(19) United States
(12) Patent Application Publication
(10) Pub. No.: US 2014/0058030 A1
(43) Pub. Date: Feb. 27, 2014

(54) SILANE-TERMINATED POLYURETHANE AND RUBBER COMPOSITE MATERIALS

(71) Applicants: Jay A. Johnston, Clinton, PA (US); Sandrea Zielinski, Wexford, PA (US)

(72) Inventors: Jay A. Johnston, Clinton, PA (US); Sandrea Zielinski, Wexford, PA (US)

(73) Assignee: Bayer MaterialScience LLC, Pittsburgh, PA (US)

(21) Appl. No.: 13/592,600

(22) Filed: Aug. 23, 2012

(51) Int. Cl. C08L 75/04; C08L 77/00; C08L 21/00

(52) U.S. Cl. CPC C08L 75/04; C08L 21/00; C08L 77/00
USPC 524/502; 525/130

(57) ABSTRACT

Composite materials including rubber particles and silane-terminated polyurethane binders are disclosed.

### TECHNICAL FIELD

This disclosure generally relates to composite materials including rubber particles and silane-terminated polyurethane binders. This disclosure also relates to cured articles comprising composite materials including rubber particles and silane-terminated polyurethane binders.

### BACKGROUND

Rubber particles may be bonded together to form composite materials using various resins, such as, for example, urethane resins. Composite materials comprising rubber particles and binding resins may find utility in a number of applications. For example, U.S. Pat. Nos. 5,094,905; 5,527,409; 6,565,918; and 6,821,623, the contents of which are incorporated by reference herein, disclose various articles made from materials comprising ground or shredded tire rubber particles bonded together with adhesives or other resins, including urethane resins.

Urethane-based resins used to bind rubber particles together are formed from compounds containing isocyanate functional groups (—NCO). Isocyanate-containing resins also tend to excessively foam when exposed to relatively high humidity environments or wet substrates, due to carbon dioxide produced during the isocyanate-water reaction. Foaming of urethane-based binding resins may adversely affect the physical properties and aesthetic characteristics of rubber particle composite materials. Further, aromatic polyisocyanate-based moisture-curable resins cure relatively rapidly, even without added catalysts, especially under relatively high humidity and/or high temperature conditions. A catalyst is typically added to aliphatic polyisocyanate-based moisture curable resins. The catalyst increases the possibility of the resin foaming.

Rapid curing may also decrease the pot life of urethane-based binding resins, which may increase processing difficulties in a number of rubber particle binding applications.

### SUMMARY

Embodiments disclosed herein include a composite material comprising rubber particles and a moisture-curable silane-terminated polyurethane binder. The rubber particles may have an average particle size no larger than 500 microns.

Embodiments disclosed herein also include a composite material comprising rubber particles having an average particle size no larger than 400 microns and a moisture-curable silane-terminated polyurethane binder. In various embodiments, the composite material may comprise 10-50 percent by weight rubber particles and 50-90 percent by weight silane-terminated polyurethane binder. The composite material may be cured when exposed to atmospheric moisture, forming a cured composite material. In various embodiments, the cured composite material may exhibit tensile strength of at least 100 psi, percentage elongation of at least 60%, and/or tear resistance of at least 20 pil. In various embodiments, the rubber particles may comprise cryogenically ground rubber recycled from used tires.

Embodiments disclosed herein also include a method of forming a composite material. The method comprises combining rubber particles having an average particle size no larger than 500 microns and a silane-terminated polyurethane binder to form a composite mixture, and curing the composite mixture to form the composite material.

It is understood that the invention disclosed and described herein is not limited to the embodiments disclosed in this Summary.

### BRIEF DESCRIPTION OF THE DRAWINGS

Various characteristics of the non-limiting embodiments disclosed and described herein may be better understood by reference to the accompanying figures, in which:

FIG. 1 is a bar graph showing Shore-A hardness values for cured composite materials comprising rubber particles and a silane-terminated polyurethane binder;

FIG. 2 is a bar graph showing tensile strength values for cured composite materials comprising rubber particles and a silane-terminated polyurethane binder;

FIG. 3 is a bar graph showing elongation values for cured composite materials comprising rubber particles and a silane-terminated polyurethane binder;

FIG. 4 is a bar graph showing tear resistance values for cured composite materials comprising rubber particles and a silane-terminated polyurethane binder;

FIG. 5 is a bar graph showing Shore-A hardness values for cured composite materials comprising rubber particles and either a silane-terminated polyurethane binder or an isocyanate-terminated polyurethane binder;

FIG. 6 is a bar graph showing tensile strength values for cured composite materials comprising rubber particles and either a silane-terminated polyurethane binder or an isocyanate-terminated polyurethane binder;

FIG. 7 is a bar graph showing elongation values for cured composite materials comprising rubber particles and either a silane-terminated polyurethane binder or an isocyanate-terminated polyurethane binder;

FIG. 8 is a bar graph showing tear resistance values for cured composite materials comprising rubber particles and either a silane-terminated polyurethane binder or an isocyanate-terminated polyurethane binder;

FIG. 9 is a bar graph showing tensile strength values for cured composite materials comprising a silane-terminated polyurethane binder and a blend of relatively small and large sized rubber particles;

FIG. 10 is a bar graph showing elongation values for cured composite materials comprising a silane-terminated polyurethane binder and a blend of relatively small and large sized rubber particles;

FIG. 11 is a bar graph showing tear resistance values for cured composite materials comprising a silane-terminated polyurethane binder and a blend of relatively small and large sized rubber particles;

FIG. 12 is a bar graph showing Shore-A hardness values for cured composite materials comprising a silane-terminated polyurethane binder and either 50 micron rubber particles or 400 micron rubber particles, and either no additive particles, carbon nanotubes, or nylon fibers;

FIG. 13 is a bar graph showing tensile strength values for cured composite materials comprising a silane-terminated polyurethane binder and either 50 micron rubber particles or 400 micron rubber particles, and either no additive particles, carbon nanotubes, or nylon fibers;

FIG. 14 is a bar graph showing elongation values for cured composite materials comprising a silane-terminated polyurethane binder and either 50 micron rubber particles or 400 micron rubber particles, and either no additive particles, carbon nanotubes, or nylon fibers; and

FIG. 15 is a bar graph showing tear resistance values for cured composite materials comprising a silane-terminated polyurethane binder and either 50 micron rubber particles or 400 micron rubber particles, and either no additive particles, carbon nanotubes, or nylon fibers.

The reader will appreciate the foregoing details, as well as others, upon considering the following detailed description of various non-limiting embodiments according to the present disclosure. The reader also may comprehend additional details upon implementing or using embodiments described herein.

### DETAILED DESCRIPTION OF NON-LIMITING EMBODIMENTS

It is to be understood that various descriptions of the disclosed embodiments have been simplified to illustrate only those features and characteristics that are relevant to a clear understanding of the disclosed embodiments, while eliminating, for purposes of clarity, other features and characteristics. Persons having ordinary skill in the art, upon considering the present description of the disclosed embodiments, will recognize that other features and characteristics may be desirable in a particular implementation or application of the disclosed embodiments. However, because such other features and characteristics may be readily ascertained and implemented by persons having ordinary skill in the art upon considering the present description of the disclosed embodiments, and are, therefore, not necessary for a complete understanding of the disclosed embodiments, a description of such features, characteristics, and the like is not provided herein. As such, it is to be understood that the description set forth herein is merely exemplary and illustrative of the disclosed embodiments and is not intended to limit the scope of the invention as defined by the claims.

In the present disclosure, other than where otherwise indicated, all numbers expressing quantities or characteristics are to be understood as being prefaced and modified in all instances by the term “about.”

Accordingly, unless indicated to the contrary, any numerical parameters set forth in the following description may vary depending on the desired properties one seeks to obtain in the embodiments according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited herein is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Any maximum numerical limitation recited herein is intended to include all lower numerical limitations subsumed therein and any minimum numerical limitation recited herein is intended to include all higher numerical limitations subsumed therein. Accordingly, Applicants reserve the right to amend the present disclosure, including the claims, to expressly recite any sub-range subsumed within the ranges expressly recited herein. All such ranges are intended to be inherently disclosed herein such that amending to expressly recite any such sub-ranges would comply with the requirements of 35 U.S.C. §112, first paragraph, and 35 U.S.C. §132(a).

The grammatical articles “one”, “a”, “an”, and “the”, as used herein, are intended to include “at least one” or “one or more”, unless otherwise indicated. Thus, the articles are used herein to refer to one or more than one (i.e., to “at least one”) of the grammatical objects of the article. By way of example, “a component” means one or more components, and thus, possibly, more than one component is contemplated and may be employed or used in an implementation of the described embodiments.

Any patent, publication, or other disclosure material that is said to be incorporated by reference herein, is incorporated herein in its entirety unless otherwise indicated, but only to the extent that the incorporated material does not conflict with existing definitions, statements, or other disclosure material expressly set forth in this disclosure. As such, and to the extent necessary, the express disclosure as set forth herein supersedes any conflicting material incorporated by reference herein. Any material, or portion thereof, that is said to be incorporated by reference herein, but which conflicts with existing definitions, statements, or other disclosure material set forth herein is only incorporated to the extent that no conflict arises between that incorporated material and the existing disclosure material. Applicant reserves the right to amend the present disclosure to expressly recite any subject matter, or portion thereof, incorporated by reference herein.

The present disclosure includes descriptions of various embodiments. It is to be understood that all embodiments described herein are exemplary, illustrative, and non-limiting. Thus, the present disclosure is not limited by the description of the various exemplary, illustrative, and non-limiting embodiments. Rather, the invention is defined by the claims, which may be amended to recite any features or characteristics expressly or inherently described in or otherwise expressly or inherently supported by the present disclosure. Further, Applicants reserve the right to amend the claims to affirmatively disclaim features or characteristics that may be present in the prior art. Therefore, any such amendments would comply with the requirements of 35 U.S.C. §112, first paragraph, and 35 U.S.C. §132(a). The various embodiments disclosed and described herein can comprise, consist of, or consist essentially of the features and characteristics as variously described herein.

Isocyanate-terminated polyurethane resins used to bind rubber particles together may suffer from a number of problems including, for example, foaming problems, and pot life limitations. Silane-terminated polyurethane resins are not inflammatory or sensitizing to skin or mucous membranes. Silane-terminated polyurethanes moisture-cure by an alcohol condensation cross-linking mechanism that does not produce gaseous reaction products and, therefore, does not exhibit foaming problems. Further, the alcohol condensation reaction between silane groups proceeds at a relatively lower reaction rate as compared to the isocyanate-water reaction mechanism of moisture-curing isocyanate-terminated polyurethanes. As a result, silane-terminated polyurethanes exhibit increased pot life relative to aromatic isocyanate-terminated polyurethanes.

Generally, cured isocyanate-terminated polyurethane composite materials exhibit better materials properties, i.e. physical properties, than cured silane-terminated polyurethane composite materials. For example, rubber particle composites comprising millimeter-sized rubber particles and cured isocyanate-terminated polyurethane binders generally exhibit higher tensile strength, hardness, elongation, and tear resistance than rubber particle composites comprising millimeter-sized rubber particles and cured silane-terminated polyurethane binders. However, the present inventors have discovered composite materials comprising rubber particles and silane-terminated polyurethane binders that exhibit material properties comparable to or in some cases exceeding those achieved with millimeter-sized rubber particles and cured isocyanate-terminated polyurethane binders.

As used herein, the term “cured” refers to the condition of a liquid binder composition in which a composite material comprising the binder composition is at least set-to-touch as defined in ASTM D 5895—Standard Test Methods for Evaluating Drying or Curing During Film Formation of Organic Coatings Using Mechanical Recorder, which is hereby incorporated by reference herein. As used herein, the terms “cure” and “curing” refer to the progression of a liquid binder composition from the liquid state to a cured state. The terms “cured”, “cure”, and “curing” encompass physical drying of binder compositions through solvent or carrier evaporation and chemical crosslinking of components in binder compositions, unless indicated otherwise.

As used herein, the term “polyurethane” refers to polymeric or oligomeric materials comprising urethane groups, urea groups, or both. Accordingly, as used herein, the term “polyurethane” is synonymous with the terms polyurea, poly(urethane/urea), and modifications thereof. The term “polyurethane” also refers to polymeric or oligomeric resins or crosslinked polymer networks comprising urethane groups, urea groups, or both.

As used herein, the term “polyisocyanate” refers to compounds comprising at least two unreacted isocyanate groups. Polyisocyanates include diisocyanates and diisocyanate reaction products comprising, for example, biuret, isocyanurate, uretdione, urethane, urea, iminooxadiazine dione, oxadiazine trione, carbodiimide, acyl urea, and/or allophanate groups. As used herein, the term “polyol” refers to compounds comprising at least two free hydroxyl groups. Polyols include polymers comprising at least two pendant and/or terminal hydroxyl groups. As used herein, the term “polyamine” refers to compounds comprising at least two free amine groups. Polyamines include polymers comprising at least two pendant and/or terminal amine groups.

As used herein, the term “rubber” refers to vulcanized elastomer materials that exhibit large and reversible elongations at low stresses. Rubbers are generally amorphous with a low glass transition temperature and some degree of crosslinking (vulcanization) to impart elastic material properties. Rubbers include, but are not limited to, natural and synthetic polyisoprene, polychloroprene (neoprene), polybutadiene, polyacrylonitrile, poly(styrene-co-butadiene), poly(acrylonitrile-co-butadiene), poly(isobutylene-co-isoprene), polysulfide rubbers, ethylene propylene diene monomer (EPDM) rubbers, butyl rubber, silicone rubbers, and the like. Rubber also includes blends and other combinations of vulcanized elastomer materials, including, but not limited to, tire rubber.

Embodiments disclosed herein include a composite material comprising rubber particles and a moisture-curable silane-terminated polyurethane binder. In various embodiments, the composite materials disclosed herein may comprise crumb rubber particles recycled from used tires. As used herein, the term “crumb rubber” refers to particles derived by reducing scrap rubber tire or other rubber material into particles. Generally, crumb rubber production processes for recycling tires include operations to remove any reinforcing materials such as steel and fiber, along with other contaminants such as dust, glass, rocks, and the like. Crumb rubber production processes include, but are not limited to, the grinding of vulcanized (crosslinked) rubber (for example, tire rubber) into crumb rubber particles of various sizes under ambient or cryogenic conditions.

Non-limiting examples of cryogenic grinding processes and apparatuses that produce rubber particles from recycled tires are described in U.S. Pat. Nos. 7,093,781; 7,108,207; and 7,445,170, which are incorporated by reference herein. In various embodiments, the composite materials disclosed herein may comprise crumb rubber particles produced by the processes and/or with the apparatuses described in U.S. Pat. Nos. 7,093,781; 7,108,207; and 7,445,170. Crumb rubber particles produced by the processes and/or with the apparatuses described in U.S. Pat. Nos. 7,093,781; 7,108,207; and 7,445,170 include the PolyDyne™ and the MicroDyne™ lines of products commercially available from Lehigh Technologies Inc., Tucker, Ga., USA.

Tire rubber includes various different types of rubbers depending, for example, on the tire manufacturer's formulations, the type of tire, and the spatial location of the rubber material within the tire structure. In embodiments comprising rubber particles produced from recycled tires, the vulcanized rubber particles may contain a combination of several different rubbers, as well as other tire material components, such as, for example, thermoplastic polymers, carbon black, silica, clays, anti-oxidant compounds, anti-ozonant compounds, free sulfur, other free vulcanizing agents, oils, residual fibers, residual steel, other residual contaminants, and the like.

In various embodiments, the composite materials disclosed herein may comprise rubber particles produced from rubber recycled from non-tire sources. In various embodiments, the composite materials disclosed herein may comprise rubber particles produced from a virgin rubber or combinations of virgin rubbers. Rubber particles finding utility in the disclosed composite materials may also include various additives, for example, ingredients known in the art of rubber material production and processing.

In various embodiments, the composite materials disclosed herein may comprise rubber particles having an average particle size of 40 Mesh to 300 Mesh, as determined according to ASTM D5644-01: Standard Test Methods for Rubber Compounding Materials Determination of Particle Size Distribution of Recycled Vulcanizate Particulate Rubber, incorporated by reference herein. In various embodiments, the average particle size may fall within any sub-range within 40 Mesh to 300 Mesh, as determined according to ASTM D5644-01. For example, in various embodiments, the average particle size of rubber particles may be no larger than 40 Mesh (approximately 400 microns), 80 Mesh (approximately 177 microns), 140 Mesh (approximately 105 microns), 200 Mesh (approximately 74 microns), or 300 Mesh (approximately 50 microns), as determined according to ASTM D5644-01.

In various embodiments, the rubber particles may have an average particle size no larger than any value in the range of 50 microns to 500 microns. In various embodiments, the rubber particles may have an average particle size no larger than any value in any sub-range within 50 microns to 500 microns. For example, the rubber particles may have an average particle size no larger than 500 microns, 400 microns, 300 microns, 200 microns, 100 microns, 75 microns, or 50 microns.

The composite materials disclosed herein may comprise ground rubber particles produced from recycled rubber tires having an average particle size of 40 Mesh to 300 Mesh, or any sub-range or value within 40 Mesh to 300 Mesh, as determined according to ASTM D5644-01. The composite materials disclosed herein may comprise ground rubber particles produced from recycled rubber tires having an average particle size no larger than any value in the range of 50 microns to 500 microns, or any sub-range or value within 50 microns to 500 microns. In various embodiments, the ground rubber particles produced from recycled rubber tires are cryogenically ground.

The composite materials disclosed herein also comprise a silane-terminated polyurethane binder. Examples of silane-terminated polyurethanes that may find utility as binders are described in EP 1924621 and U.S. Pat. Nos. 3,933,756; 5,756,751; 6,288,198; 6,545,087; 6,703,453; 6,809,170; 6,833,423; 6,844,413; 6,887,964; 6,998,459; 7,115,696; 7,465,778; 7,060,750; and 7,309,753, which are incorporated by reference herein.

One-component moisture-curable polyurethane resins generally contain unreacted isocyanate groups that react with atmospheric water molecules to form a carbamic acid intermediate that decomposes into amine groups and carbon dioxide. The amine groups formed in situ by way of the isocyanate-water reaction react with additional unreacted isocyanate groups to form urea crosslinks between resin molecules. In this manner, a resin may be exposed to moisture and cured to form cross-linked polyurethane. In like manner, silane-terminated polyurethanes comprise unreacted alkoxy-silane or acetoxy-silane groups that hydrolyze to silanol groups when exposed to water molecules. The silanol groups react with additional unreacted alkoxy-silane or acetoxy-silane groups to form silicone crosslinks (—Si—O—Si—) between resin molecules. In this manner, silane-terminated polyurethane resin may be exposed to moisture and cured to form cross-linked polyurethane.

In various embodiments, a moisture-curable silane-terminated polyurethane binder comprises an isocyanate-aminosilane adduct comprising a reaction product of an isocyanate-functional polyurethane and an aminosilane, wherein the silane groups are incorporated into the polyurethane through urea bonds by the reaction of a unreacted isocyanate group in the polyurethane with an amine group in the aminosilane.

In various embodiments, the isocyanate-functional polyurethane may comprise a polyether urethane. A polyether urethane may be produced, for example, by reacting a high molecular weight polyether containing at least two isocyanate-reactive groups, such as, for example, hydroxyl groups or amine groups, with an excess of a polyisocyanate, such as, for example, a diisocyanate, to form the polyurethane. The resulting isocyanate-functional polyurethane may then be reacted with an aminosilane to form a silane-terminated polyurethane. Silane-terminated polyurethanes containing a polyether segment may also be prepared by reacting an excess of a polyisocyanate with an aminosilane to form a monoisocyanate and then reacting the resulting intermediate monoisocyanate with a high molecular weight polyether polyol.

In various embodiments, silane-terminated polyurethanes may contain one or more polyether segments having a number average molecular weight of 3,000 to 20,000; 6000 to 15,000; or 8000 to 12,000. The polyether segments may be formed from polyether polyols by reaction with polyisocyanates. Polyether polyols for preparing isocyanate-terminated polyurethanes include, but are not limited to, polyether polyols having a number average molecular weight of at least 3,000, at least 6000, or at least 8000. In various embodiments, the number average molecular weight of the polyether polyol can be up to 20,000, up to 15,000, or up to 12,000. The number average molecular weight of the polyether polyol can vary and range between any of the values recited above. In various embodiments, the polyether polyol may be a polyether diol.

In various embodiments, the polyethers may have a maximum total degree of unsaturation of 0.1 milliequivalents/gram (meq/g) or less, 0.04 meq/g or less, 0.02 meq/g or less, 0.01 meq/g or less, 0.007 meq/g or less, or 0.005 meq/g or less. The amount of unsaturation may vary depending on the method used to prepare the polyether as well as the molecular weight of the polyether. For example, polyether diols may be produced, for example, by the propoxylation of suitable starter molecules. As another example, amounts of ethylene oxide may also be used (for example, up to 20% by weight, based on the weight of the polyol). If ethylene oxide is used, it may be used as the initiator for or to cap the polypropylene oxide groups. Examples of suitable starter molecules include, but are not limited to, diols, such as, for example, ethylene glycol, propylene glycol, 1,3-butanediol, 1,4-butanediol, 1,6 hexanediol, and 2-ethylhexane-diol-1,3. Polyethylene glycols and polypropylene glycols are also suitable as starter molecules.

Examples of methods for preparing polyether polyols are described in U.S. Pat. Nos. 3,278,457; 3,427,256; 3,829,505; 4,472,560; 3,278,458; 3,427,334; 3,941,849; 4,721,818; 3,278,459; 3,427,335; and 4,355,188, which are incorporated by reference herein. In various embodiments, silane-terminated polyurethanes containing one or more polyether segments may be formed from polyether polyamines by reaction with polyisocyanates. Polyether polyamines may be produced by aminating corresponding polyether polyols using chemical techniques known in the art. In various embodiments, polyether polyols used to produce isocyanate-functional polyurethanes include polyoxyalkylene diols, such as, for example, polyoxypropylene diols, polyoxyethylene diols, or poly(oxypropylene/oxyethylene) diols.

Suitable polyisocyanates which may be used to produce silane-terminated polyurethanes include aromatic, aliphatic, and/or cycloaliphatic polyisocyanates. Aromatic, aliphatic, and/or cycloaliphatic polyisocyanates may include monomeric organic diisocyanates represented by the formula, R(NCO)₂, in which R represents an organic group. In various embodiments, R represents a divalent aliphatic hydrocarbon group having from 4 to 18 carbon atoms, a divalent cycloaliphatic hydrocarbon group having from 5 to 15 carbon atoms, a divalent araliphatic hydrocarbon group having from 7 to 15 carbon atoms, or a divalent aromatic hydrocarbon group having 6 to 15 carbon atoms.

Examples of suitable diisocyanates include: 1,4-tetra-methylene diisocyanate; 1,6-hexamethylene diisocyanate (HDI); 2,2,4-trimethyl-1,6-hexamethylene diisocyanate; 1,12-dodecamethylene diisocyanate; cyclohexane-1,3- and -1,4-diisocyanate; 1-isocyanato-2-isocyanatomethyl cyclopentane; 1-isocyanato-3-isocyanatomethyl-3,5,5-trimethyl-cyclohexane (isophorone diisocyanate or IPDI), bis-(4-isocyanato-cyclohexyl)-methane; 1,3- and 1,4-bis-(isocyanatomethyl)-cyclohexane; bis-(4-isocyanatocyclo-hexyl)-methane; 2,4′-diisocyanato-dicyclohexyl methane; bis-(4-isocyanato-3-methyl-cyclohexyl)--methane; α,α,α′,α′-tetramethyl-1,3- and/or -1,4-xylylene diisocyanate; 1-isocyanato-1-methyl-4(3)-isocyanatomethyl cyclohexane; 2,4- and/or 2,6-hexahydro-toluylene diisocyanate; 1,3- and/or 1,4-phenylene diisocyanate; 2,4- and/or 2,6-tolune diisocyanate; 2,4- and/or 4,4′-diphenylmethane diisocyanate (MDI); 1,5-diisocyanato naphthalene; and combinations of any thereof.

Monomeric polyisocyanates containing three or more isocyanate groups such as 4-isocyanatomethyl-1,8-octamethylene diisocyanate and aromatic polyisocyanates such as 4,4′,4″-triphenylmethane triisocyanate and polyphenyl polymethylene polyisocyanates obtained by phosgenating aniline/formaldehyde condensates may also be used to prepare isocyanate-functional polyurethanes. Also suitable are polyisocyanate adducts prepared from monomeric polyisocyanates (including diisocyanates) and containing isocyanurate, uretdione, biuret, urethane, allophanate, iminooxadiazine dione, carbodiimide, and/or oxadiazinetrione groups.

Suitable aminosilanes that may be used to produce silane-terminated polyurethanes include compounds corresponding to the formula:

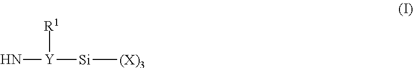

In the above formula, X represents identical or different organic groups which are inert to isocyanate groups below 100° C., provided that at least one of these groups are alkoxy or acyloxy groups. In various embodiments, X represents an alkyl or alkoxy group having 1 to 4 carbon atoms. Y represents a linear or branched alkylene group containing 1 to 8 carbon atoms. In various embodiments, Y represents a linear group containing 2 to 4 carbon atoms or a branched group containing 5 to 6 carbon atoms. R¹ represents hydrogen or an organic group which is inert to isocyanate groups at a temperature of 100° C. or less. In various embodiments, R¹ represents an alkyl, cycloalkyl, or aromatic group having 1 to 12 carbon atoms, or R¹ represents a group corresponding to the formula:

—Y—Si—(X)₃ (II)

In the above formula, X and Y have the same meanings described above.

In various embodiments, X represents methoxy, ethoxy, or propoxy groups, and Y is a linear alkylene group containing 3 carbon atoms (i.e., a propylene group).

Examples of suitable aminosilanes corresponding to formula (I), which contain secondary amino groups, include, but are not limited to, N-phenylaminopropyl-trimethoxysilane (available as A-9669 from OSI Corporation); bis-(γ-trimethoxysilylpropyl)amine (available as A-1170 from OSI Corporation); N-cyclohexylaminopropyl-triethoxysilane; N-methylaminopropyl-trimethoxysilane; N-butylaminopropyl-trimethoxysilane; N-butylaminopropyl-triacyloxysilane; 3-(N-ethyl)amino-2-methylpropyl-trimethoxysilane; 4-(N-ethyl)amino-3,3-dimethylbutyl-trimethoxysilane; and the corresponding alkyl diethoxy, alkyl dimethoxy, and alkyl diacyloxysilanes, such as, for example, 3-(N-ethyl)amino-2-methylpropyl-methyldimethoxysilane.

In various embodiments, aminosilanes used to produce silane-terminated polyurethanes may include compounds corresponding to the formula:

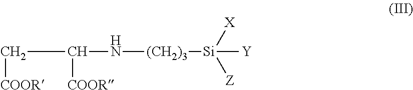

In the above formula, R′ and R″ represent identical or different alkyl radicals comprising 1 to 8 carbon atoms, and X, Y, Z represent identical or different C₁-C₈ alkyl or C₁-C₈ alkoxy radicals comprising 1 to 4 carbon atoms, with the proviso that at least one of the radicals represents a C₁-C₈ alkoxy group. In various embodiments, X, Y and Z in formula (III), independently of each other, represent methoxy or ethoxy groups.

In various embodiments, when preparing silane-terminated polyurethanes from polyisocyanates, polyols, and aminosilanes, the polyisocyanates are reacted with the polyols at an equivalent ratio of isocyanate groups to hydroxyl groups (NCO:OH) of 1.2:1 to 2:1 to form an isocyanate-functional polyurethane. In various embodiments, the NCO:OH ratio may be in any range within 1.2:1 to 2:1, such as, for example, 1.2:1 to 1.8:1 or 1.3:1 to 1.6:1. The reaction between polyisocyanates and polyols may be performed within the temperature range from 40° C. to 120° C. and in various embodiments, from 50° C. to 100° C. During the production of isocyanate-functional polyurethanes, amine or organometallic catalysts, which are known in the art of polyurethane chemistry, may optionally be used.

In various embodiments, the isocyanate-functional polyurethanes may have an average molecular weight from 15,000 to 50,000 as calculated from the NCO content and NCO functionality. The isocyanate-functional polyurethanes may have an average molecular weight falling within any range within 15,000 to 50,000, such as, for example, 20,000 to 40,000. The isocyanate-functional polyurethanes may have an NCO content from 021% to 0.56%, or any range within 0.21% to 0.56%, such as, for example, 0.28 to 0.42%.

The isocyanate-functional polyurethanes may be reacted with the aminosilane at an equivalent ratio of isocyanate groups to amino groups of approximately 1:1. For example, the quantitative ratios may be selected so that 0.95 to 1.1 moles of aminosilane compound are used per mole of free isocyanate group in the isocyanate-functional polyurethanes. The reaction of the isocyanate-functional polyurethanes with aminosilanes may be conducted within a temperature range from 0° C. to 150° C., or any range within 0° C. to 150° C., such as, for example, 20° C. to 80° C.

The resulting silane-terminated polyurethane contains reaction products of the isocyanate-functional polyurethanes and the aminosilanes. In addition, reaction products of residual monomeric diisocyanates with aminosilanes may form. In various embodiments, diisocyanate-aminosilane reaction products may be present in an amount of less then 2% by weight or less than 1% by weight, based on the total weight of all the reaction products. In various embodiments, diisocyanate-aminosilane reaction products may be present in an amount of at least 0.1% by weight or at least 0.5% by weight, based on the total weight all the reaction products.

In addition to silane-terminated polyurethane resins, binders for the composite materials disclosed herein may optionally include plasticizers, fillers, pigments, drying agents, additives, light stabilizers, antioxidants, thixotropic agents, catalysts, bonding agents, and/or other adjuvant substances and additives. Examples of fillers include carbon black, precipitated hydrated silicas, mineral chalk materials, and precipitated chalk materials. Examples of plasticizers include phthalic acid esters, adipic acid esters, alkylsulfonic acid esters of phenol, or phosphoric acid esters. Examples of thixotropic agents include pyrogenic hydrated silicas, polyamides, products derived from hydrogenated castor oil, and polyvinyl chloride.

Examples of alcohol condensation silane-curing reaction catalysts include organo-tin compounds and amine catalysts. Examples of organo-tin compounds include dibutyltin diacetate, dibutyltin dilaurate, dibutyltin bis-acetoacetonate, and tin carboxylates, such as, for example, tin octoate. Tin catalysts can optionally be used in combination with amine catalysts such as aminosilanes or diazabicycloalkenes. Examples of drying agents include alkoxysilyl compounds, such as, vinyl trimethoxysilane, methyl trimethoxysilane, 1-butyl trimethoxysilane, and hexadecyl trimethoxysilane. Examples of bonding agents include free aminosilanes, epoxysilanes, and/or mercaptosilanes.

Examples of commercially available silane-terminated polyurethanes that may find utility in the composite materials disclosed herein include the Desmoseal® line of silane-terminated polyurethanes commercially available from Bayer MaterialScience LLC. For example, a composite material according to various embodiments disclosed herein may include a binder comprising Desmoseal® S XP 2636, which is a one-component, moisture-curing, 100% solids, silane-terminated polyurethane. Other Desmoseal® resins such as Desmoseal® S XP 2749 can also be used.

In various embodiments, the composite material disclosed herein may comprise 10-50 percent by weight rubber particles and 50-90 percent by weight silane-terminated polyurethane binder. In various embodiments, the composite material may comprise rubber particles in any amount in any sub-range within 10-50 weight percent, such as, for example. 25-50 percent or 30-45 percent. In various embodiments, the composite material may comprise silane-terminated polyurethane binder in any amount in any sub-range within 50-90 weight percent, such as, for example, 50-75 percent or 55-70 percent.

In various embodiments, the composite material disclosed herein may comprise 9-50 percent by volume rubber particles and 50-91 percent by volume silane-terminated polyurethane binder. In various embodiments, the composite material may comprise rubber particles in any amount in any sub-range within 9-50 volume percent, such as, for example, 25-50 percent or 30-45 percent. In various embodiments, the composite material may comprise silane-terminated polyurethane binder in any amount in any sub-range within 50-90 volume percent, such as, for example, 50-75 percent or 55-70 percent.

In various embodiments, the composite material may comprise blends of rubber particles of different chemical composition, different particle size, and/or different production method. In various embodiments, the composite material may comprise non-rubber particles, such as, for example, carbon nanotubes, nylon fibers,carbon black, silicon dioxide (sand), talc, titanium dioxide, calcium carbonate, etc. Non-rubber additive particles may function as property modifiers for the composite materials disclosed herein.

In various embodiments, solid rubber particles and liquid silane-terminated polyurethane binder (and any other components or additives) are mixed together using mixing techniques known in the art to form uncured composite materials as disclosed herein. The uncured composite materials may then be exposed to moisture and cured. Alternatively, the uncured composite materials may be stored for limited periods of time provided that the mixture does not contact appreciable moisture.

The composite materials comprising rubber particles and silane-terminated polyurethane binder, as disclosed herein, cure when exposed to moisture, thereby forming a cured composite material. The moisture may be provided by exposing the composite material to an ambient environment containing atmospheric moisture. Further, the composite materials disclosed herein may be cured by exposing the composition to predetermined moisture levels and temperatures to more precisely control the curing rate. This may be performed in a controlled temperature and humidity room, for example.

When exposed to moisture, silane-terminated polyurethane binder undergoes an alcohol-condensation silane-crosslinking reaction and the liquid binder solidifies. Further, any binder solvents or carriers may be evaporated by exposing the composite material to atmosphere to aid in curing the composite material. In this manner, the uncured composite material cures and forms a solid composite material comprising solid rubber particles bonded together with a solid polyurethane matrix comprising silicone crosslinking bonds.

In various embodiments, the cured composite materials disclosed herein may exhibit tensile strength of at least 100 psi. In various embodiments, the cured composite materials disclosed herein may exhibit tensile strength of at least any value within 100-210 psi, such as, for example, at least 125 psi, at least 150 psi, at least 175 psi, at least 200 psi, or at least 205 psi.

In various embodiments, the cured composite materials disclosed herein may exhibit percentage elongation of at least 60%. In various embodiments, the cured composite materials disclosed herein may exhibit percentage elongation of at least any value within 60-115%, such as, for example, at least 75%, at least 100%, or at least 110 percent.

In various embodiments, the cured composite materials disclosed herein may exhibit tear resistance of at least 20 pil. In various embodiments, the cured composite materials disclosed herein may exhibit tear resistance of at least any value within 25-55 pil, such as, for example, at least 30 pil, at least 40 pil, or at least 50 pil.

The composite materials disclosed herein may be used to produce various articles of manufacture. For example, articles of manufacture comprising the composite materials disclosed herein may include, but are not limited to, running tracks, wrestling mats, other sports surfaces, children's play area mats, resilient floor/ground mats for humans and/or animals, truck bed-liner mats, landscaping articles, construction materials (for example, roof sheeting), speed bumps, bumpers (for example, on boat docks, truck loading docks, or in automobile parking lots), rail-road crossing pads, gaskets, sound-absorbing panels, and bases for a traffic control devices.

Embodiments disclosed herein also include a method of forming a composite material comprising combining rubber particles and a silane-terminated polyurethane binder to form a composite mixture, and then curing the composite mixture to form the composite material. The method of forming a composite material may be characterized by any of the features or characteristics variously described herein. For example, in various embodiments, a method of forming a composite material may include curing the composite mixture by exposing the composite mixture to atmospheric moisture. In various embodiments, a method of forming a composite material may include curing the composite mixture by exposing the composite mixture to predetermined moisture levels and temperatures to more precisely control the curing rate. This may be performed in a controlled temperature and humidity room, for example. Alternatively, water can be added directly to the rubber-binder mixture. Alternately, the catalyst level can be increased or decreased to change the cure rate.

In various embodiments, a composite material formed by curing a composite mixture according to methods described herein may comprise 35-50 percent by weight rubber particles and 50-65 percent by weight silane-terminated polyurethane binder. In various embodiments, a composite material formed by curing a composite mixture according to methods described herein may exhibit one or more material properties selected from the group consisting of tensile strength of at least 100 psi, percentage elongation of at least 60%, tear resistance of at least 20 pil, and combinations of any thereof, or selected from the group consisting of tensile strength of at least 200 psi, percentage elongation of at least 100%, tear resistance of at least 30 pil, and combinations of any thereof.

In various embodiments, a method of forming a composite material may comprise combining cryogenically ground rubber particles recycled from used tires and a silane-terminated polyurethane binder to form a composite mixture. The rubber particles may have an average particle size no larger than 400 microns, for example. The silane-terminated polyurethane binder may comprise a reaction product of an amino-functional silane compound and a polyisocyanate, wherein the polyisocyanate comprises a reaction product of a polyether polyol and a diisocyanate, for example. The composite mixture may be cured to form a composite material as described herein.

In various embodiments, a method of forming a composite material may comprise combining a property modifier with the rubber particles and the silane-terminated polyurethane binder. The property modifier may be selected from the group consisting of carbon nanotubes and nylon fibers, for example.

The illustrative and non-limiting examples that follow are intended to further describe various non-limiting embodiments without restricting the scope of the embodiments. Persons having ordinary skill in the art will appreciate that variations of the Examples are possible within the scope of the invention as defined by the claims. All parts and percents are by weight unless otherwise indicated.

### EXAMPLES

### Example 1

A series of composite materials comprising rubber particles and a silane-terminated polyurethane binder were prepared with varying amounts of rubber particles and silane-terminated polyurethane binder. The compositions also included 1,5-diazabicyclo[4.3.0]-non-5-ene (DBN) curing catalyst. The rubber particles were cryogenically ground 300 Mesh (per ASTM D5644-01) recycled tire rubber particles, which were commercially available as Microdyne™ 300 (Lehigh Technologies Inc., Tucker, Ga., USA). The tire rubber particles appeared as a fine black powder and had an average particle size of less than 50 microns (d10=16.32 microns, d50=34.63 microns, and d75=45.59 microns, determined using a CILAS™ 930e Particle Size Analyzer). The silane-terminated polyurethane binder was Desmoseal® S XP 2636 (Bayer MaterialScience LLC, Pittsburgh, Pa., USA).

The relative compositions (weight percentage) of the uncured composite materials are presented in Table 1. The volume percentages of the rubber particles in the uncured composite materials are also presented.

TABLE 1

| Compo- | | | | | | | | | |
|---|---|---|---|---|---|---|---|---|---|
| nent | A | B | C | D | E | F | G | H | I |
| silane- | 99.75 | 89.77 | 79.81 | 78.4 | 68.74 | 63.49 | 58.87 | 53.62 | 48.71 |
| termi- | | | | | | | | | |
| nated | | | | | | | | | |
| poly- | | | | | | | | | |
| ure- | | | | | | | | | |
| thane | | | | | | | | | |
| binder | | | | | | | | | |
| rubber | 0 | 10.01 | 19.99 | 19.64 | 29.54 | 34.92 | 39.36 | 44.77 | 48.86 |
| particles | | | | | | | | | |
| DBN | 0.25 | 0.22 | 0.20 | 1.96 | 1.72 | 1.59 | 1.77 | 1.61 | 2.44 |
| vol % | 0 | 9 | 18 | 18 | 27 | 32 | 37 | 42 | 46 |
| rubber | | | | | | | | | |

The rubber particles, binder, and DBN were combined and spin mixed at 2400 RPM for 1 minute. The resulting mixture was applied to a plastic substrate as a 100 mil drawdown layer. The composite material layers were placed under standard laboratory conditions (approximately 23° C.) and allowed to moisture cure for a minimum of seven days. The composites materials exhibited no foaming during or after cure.

The cured composite materials were removed from the plastic-substrates and evaluated for Shore-A hardness (ASTM D2240: Standard Test Method for Rubber Property-Durometer Hardness, incorporated by reference herein), tensile strength and percentage elongation (ASTM D412: Standard Test Methods for Vulcanized Rubber and Thermoplastic Elastomers-Tension, incorporated by reference herein), and tear resistance (ASTM D624 (Die C)), incorporated by reference herein).

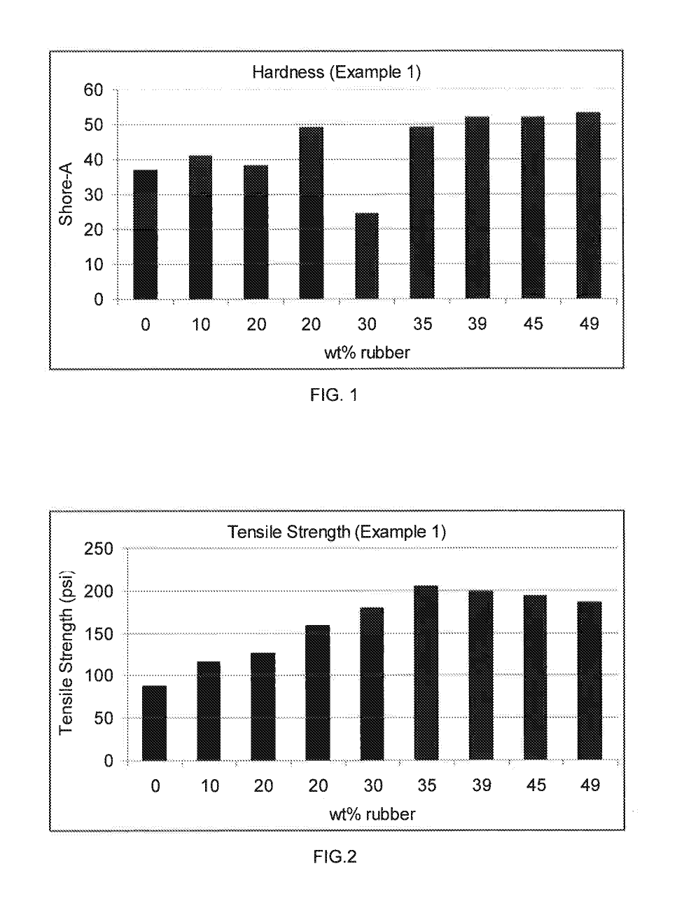

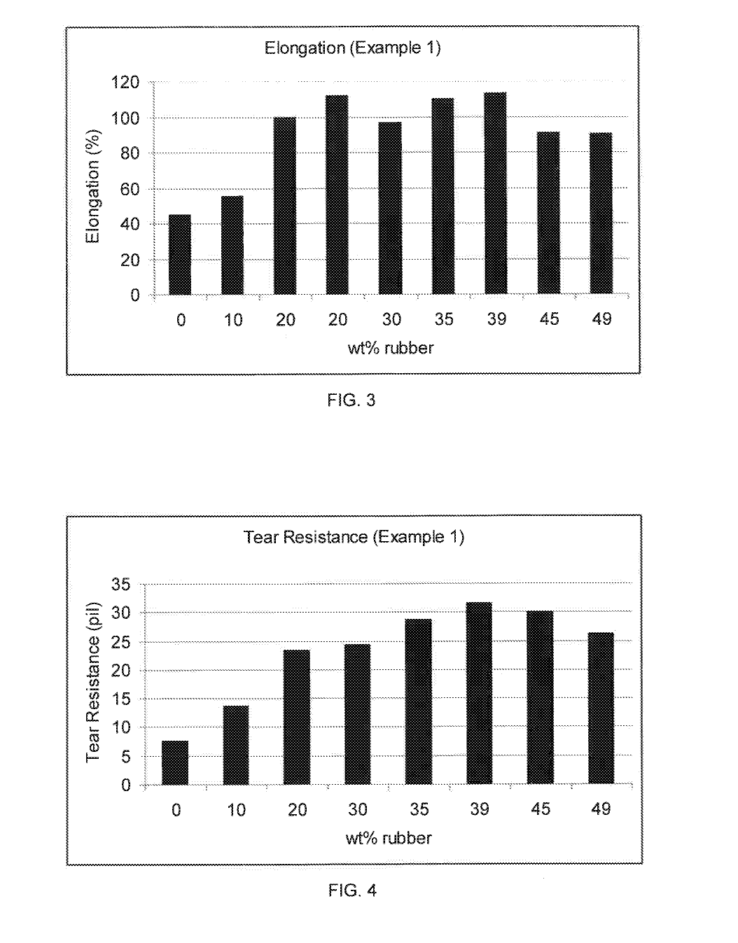

The results of the material property testing are presented in Table 2 and FIGS. 1-4.

TABLE 2

| Prop- | | | | | | | | | |
|---|---|---|---|---|---|---|---|---|---|
| erty | A | B | C | D | E | F | G | H | I |
| hard- | 37.0 | 41.0 | 38.0 | 49.0 | 24.3 | 49.9 | 62.0 | 52.0 | 53.0 |
| ness | | | | | | | | | |
| (Shore- | | | | | | | | | |
| A) | | | | | | | | | |
| tensile | 87.7 | 115.7 | 126.3 | 158.3 | 179 | 204.7 | 198.7 | 193 | 185.7 |
| strength | | | | | | | | | |
| (psi) | | | | | | | | | |
| elon- | 44.9 | 55.5 | 100.0 | 111.8 | 96.5 | 110.0 | 113.4 | 91.2 | 90.4 |
| gation | | | | | | | | | |
| (%) | | | | | | | | | |
| tear | 7.6 | 13.7 | 18.3 | 23.4 | 24.3 | 28.8 | 31.5 | 30.0 | 26.3 |
| resist- | | | | | | | | | |
| ance | | | | | | | | | |
| (pil) | | | | | | | | | |

The composites comprising rubber particles and a silane-terminated polyurethane binder exhibited good material properties, i.e. physical properties. The maximum material property values generally correlated with rubber content of 35-50 weight percent.

### Example 2

A composite material comprising 50% by weight rubber particles and 50% by weight of an isocyanate-terminated polyurethane binder was prepared for comparative purposes. The rubber particles were the same cryogenically ground 300 Mesh recycled tire rubber particles used in Example 1. The isocyanate-terminated polyurethane binder was Baytec® MP-101 (Bayer MaterialScience LLC, Pittsburgh, Pa., USA), which is a moisture-curable MDI-terminated polyurethane based on polypropylene glycol.

The rubber particles and binder were combined and spin mixed at 2400 RPM for 1 minute. The resulting mixture was applied to a plastic substrate as a 100 mil drawdown layer. The composite material layers were placed under standard laboratory conditions (approximately 23° C.) and allowed to moisture cure for a minimum of seven days.

The cured composite materials were evaluated for Shore-A hardness (ASTM D2240), tensile strength and percentage elongation (ASTM D412), and tear resistance (ASTM D624 (Die C)). These material properties were compared to the material properties exhibited by the composite material designated “I” in Example 1, which comprised about 50% by weight of the same rubber particles and 50% by weight of a silane-terminated polyurethane binder. The results are presented in Table 3.

TABLE 3

| | silane-terminated | isocyanate-terminated |
|---|---|---|
| Property | polyurethane binder | polyurethane binder |
| hardness | 53.0 | 50.0 |
| (Shore-A) | | |
| tensile strength | 185.7 | 167.0 |
| (psi) | | |
| elongation (%) | 90.4 | 72.0 |
| tear resistance | 26.3 | 28.0 |
| (pil) | | |

The composite material comprising the silane-terminated polyurethane binder exhibited comparable or slightly better materials properties than the isocyanate-terminated polyurethane binder.

### Example 3

A series of composite materials comprising rubber particles and either a silane-terminated polyurethane binder or an isocyanate-terminated polyurethane binder were prepared with varying amounts of rubber particles. The rubber particles comprised EPDM rubber having an average particle size of 1-3 millimeters. The silane-terminated polyurethane binder was Desmoseal® S XP 2636 (Bayer MaterialScience LLC, Pittsburgh, Pa., USA). The isocyanate-terminated polyurethane binder was Baytec® MP-101 (Bayer MaterialScience LLC, Pittsburgh, Pa., USA). The relative compositions (weight percentage) of the uncured composite materials are presented in Table 4.

TABLE 4

| Component | A | B | C | D |
|---|---|---|---|---|
| rubber | 79.88 | 79.59 | 69.84 | 59.78 |
| particles | | | | |
| isocyanate- | 20.12 | — | — | — |
| terminated | | | | |
| polyurethane | | | | |
| binder | | | | |
| silane- | — | 20.04 | 29.84 | 39.95 |
| terminated | | | | |
| polyurethane | | | | |
| binder | | | | |
| DBN | — | 0.36 | 0.32 | 0.27 |

The rubber particles, binder, and DBN, if present, were combined and hand mixed. The resulting mixture was placed in a 0.25×10×12 metal mold and spread flush using a trowel. The composite material layers were placed in a controlled room under standard laboratory conditions (approximately 23° C.) and allowed to moisture cure for a minimum of seven days.

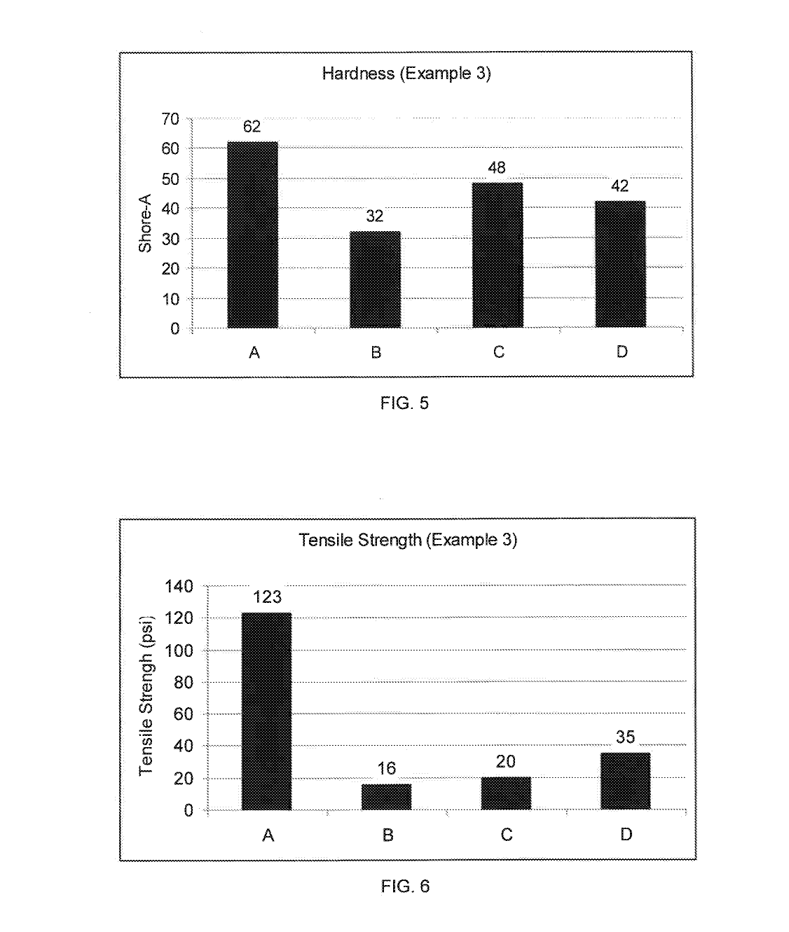

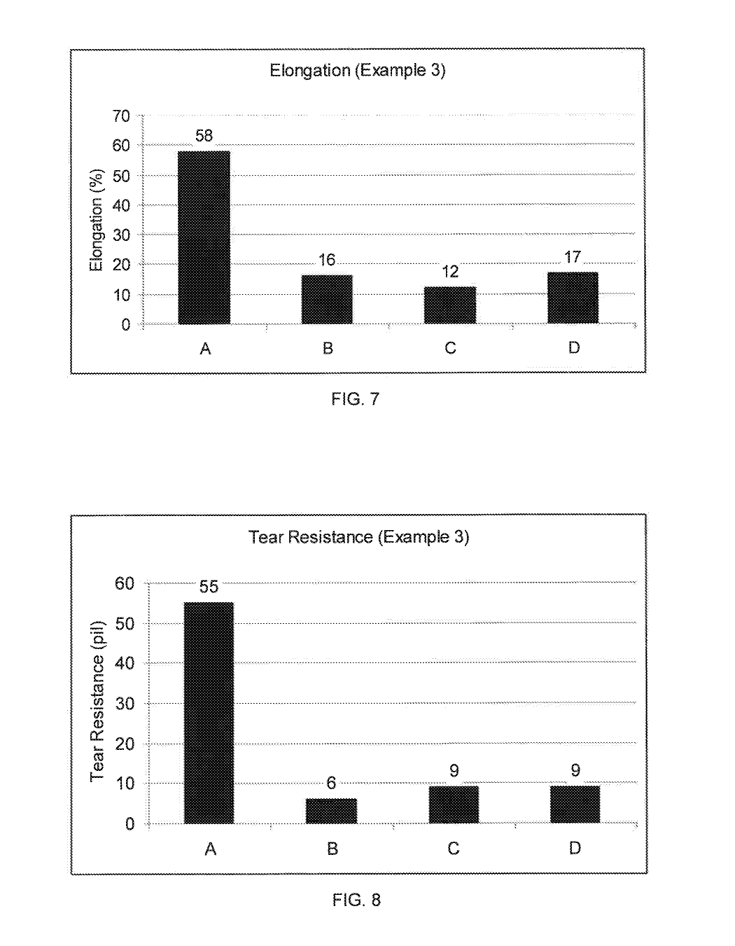

The cured composite materials were evaluated for Shore-A hardness (ASTM D2240), tensile strength and percentage elongation (ASTM D412), and tear resistance (ASTM D624 (Die C)). The results are presented in Table 5 and FIGS. 5-8.

TABLE 5

| Property | A | B | C | D |
|---|---|---|---|---|
| hardness (Shore-A) | 65 | 32 | 48 | 42 |
| tensile strength (psi) | 123 | 16 | 20 | 35 |
| elongation (%) | 58 | 16 | 12 | 17 |
| tear resistance (pil) | 55 | 6 | 9 | 9 |

The composite material comprising isocyanate-terminated polyurethane binder (A) and 1-3 millimeter rubber particles exhibited substantially better material properties than the composite materials comprising silane-terminated polyurethane binder and 1-3 millimeter rubber particles (B-D).

However, as shown in Examples 1 and 2, composite materials comprising silane-terminated polyurethane binder and smaller rubber particles exhibit comparable or better material properties than composite materials comprising isocyanate-terminated polyurethane binder and smaller rubber particles. The material properties exhibited by composite materials comprising silane-terminated polyurethane binder and smaller rubber particles are therefore unexpected. It is noted that more binder was required to wet out the smaller rubber particles (Examples 1 and 2) as compared to the larger rubber particles (Example 3).

### Example 4

A series of composite materials comprising rubber particles and either a silane-terminated polyurethane binder or an isocyanate-terminated polyurethane binder were prepared with varying amounts of rubber particles. The rubber particles were virgin EPDM rubber having an average particle size of 1-3 millimeters. The silane-terminated polyurethane binder was Desmoseal® S XP 2636 (Bayer MaterialScience LLC, Pittsburgh, Pa., USA). The isocyanate-terminated polyurethane binder was Baytec® MP-101 (Bayer MaterialScience LLC, Pittsburgh, Pa., USA). The relative compositions (part-by-weight) of the uncured composite materials are presented in Table 6. The level of binder in each composite material is also presented in weight percent.

TABLE 6

| Component | A | B | C | D | E | F | G | H |
|---|---|---|---|---|---|---|---|---|
| rubber | 90.0 | 117.6 | 110.0 | 110.0 | 110.0 | 110.0 | 110.0 | 110.0 |
| particles | | | | | | | | |
| isocyanate- | 10.0 | 17.6 | 27.7 | 47.0 | 73.5 | — | — | — |
| terminated | | | | | | | | |
| polyurethane | | | | | | | | |
| binder | | | | | | | | |
| silane- | — | — | — | — | — | 27.7 | 47.0 | 73.5 |
| terminated | | | | | | | | |
| polyurethane | | | | | | | | |
| binder | | | | | | | | |
| DBN | — | — | — | — | — | 0.5 | 0.5 | 0.5 |
| binder level | 10 | 13 | 20 | 30 | 40 | 20 | 30 | 40 |
| (weight | | | | | | | | |
| percent) | | | | | | | | |

The rubber particles and isocyanate terminate prepolymer were combined and hand mixed. The silane terminated binder and DBN, if present, were mixed on a speed mixer. The rubber particles were incorporated with hand mixing. The resulting mixtures were respectively poured into separate compartments in a single metal pan. The pan was placed in a controlled room at 50% relative humidity and 25° C. and allowed to moisture cure for 3 days.

The cured composite materials were each visually inspected for foaming and volume expansion. The results are presented in Table 7.

TABLE 7

| | isocyanate-terminated | | | | | silane-terminated | | |
|---|---|---|---|---|---|---|---|---|
| | binder | | | | | binder | | |
| | A | B | C | D | E | F | G | H |
| binder level | 10 | 13 | 20 | 30 | 40 | 20 | 30 | 40 |
| (wt %) | | | | | | | | |
| foam | No | No | No | Yes | Yes | No | No | No |
| volume | No | No | No | Yes | Yes | No | No | No |
| expansion | | | | | | | | |

Increasing the binder level results in foaming and volume expansion in isocyanate-terminated binders during curing of rubber composites. Increasing the binder level does not result in foaming or volume expansion in silane-terminated binders during curing of rubber composites.

### Example 5

A series of composite materials comprising rubber particles and a silane-terminated polyurethane binder were prepared with varying blends of EPDM rubber particles having an average particle size of 1-3 millimeters and cryogenically ground 300 Mesh recycled tire rubber particles (Microdyne™ 300, Lehigh Technologies, Inc.). The silane-terminated polyurethane binder was Desmoseal® S XP 2636 (Bayer MaterialScience LLC, Pittsburgh, Pa., USA). The relative compositions (weight percentage) of the uncured composite materials are presented in Table 8.

TABLE 8

| Component | A | B | C | D | E |
|---|---|---|---|---|---|
| EPDM | 81.20 | 79.64 | 74.07 | 72.73 | 65.75 |
| rubber | | | | | |
| particles | | | | | |
| tire rubber | 3.99 | 5.22 | 7.29 | 8.95 | 12.32 |
| particles | | | | | |
| silane- | 14.09 | 14.81 | 18.31 | 17.92 | 21.56 |
| terminated | | | | | |
| polyurethane | | | | | |
| binder | | | | | |
| DBN | 0.72 | 0.33 | 0.33 | 0.40 | 0.37 |
| weight ratio | 0.05 | 0.07 | 0.10 | 0.12 | 0.19 |
| (tire rubber | | | | | |
| to EPDM | | | | | |
| rubber) | | | | | |

The rubber particles and binder were combined and mixed by hand. The resulting mixture was troweled into a ¼×10×12 inch aluminum mold. The aluminum mold was previously treated with a mold release agent. The composite material samples were allowed to cure under standard laboratory conditions for a minimum of seven days.

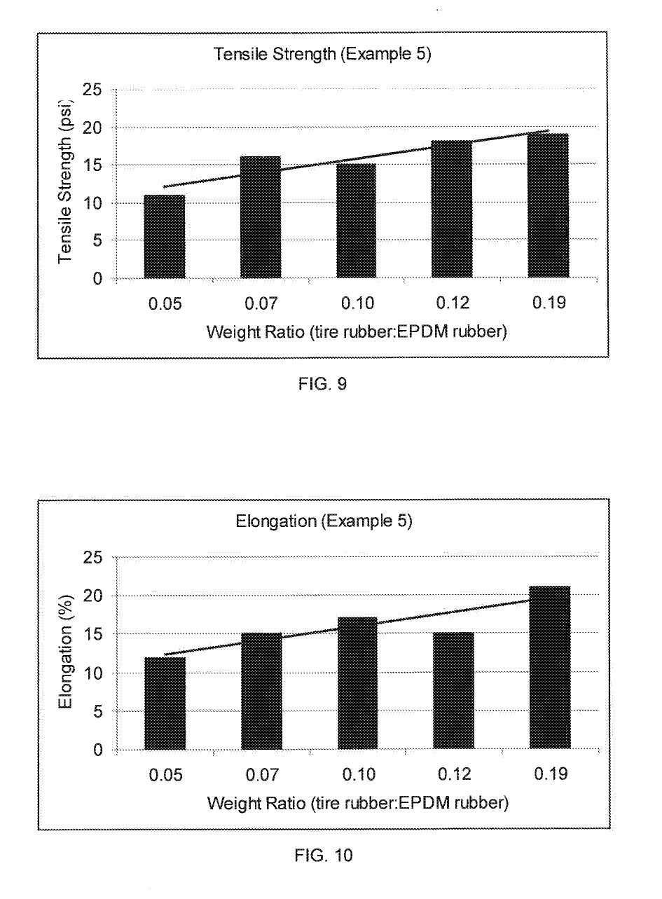

The cured composite materials were evaluated for Shore-A hardness (ASTM D2240), tensile strength and percentage elongation (ASTM D412), and tear resistance (ASTM D 624—Die C). The results are presented in Table 9 and FIGS. 9-11.

TABLE 9

| Property | A | B | C | D | E |
|---|---|---|---|---|---|
| hardness (Shore-A) | 37 | 45 | 47 | 41 | 42 |
| tensile strength (psi) | 11 | 16 | 15 | 18 | 19 |
| elongation (%) | 12 | 15 | 17 | 15 | 21 |
| tear resistance (pil) | 5 | 5 | 5 | 9 | 13 |

Increasing the amount of small rubber particles relative to the amount of large rubber particles generally corresponded to increases in tensile strength, elongation, and tear resistance, as shown in FIGS. 9-11 respectively.

### Example 6

A series of composite materials comprising rubber particles and a silane-terminated polyurethane binder were prepared with two types of cryogenically ground recycled tire rubber particles, each having average particles sizes of 300 Mesh (less than 50 microns) and 40 Mesh (less than 400 microns) (Microdyne™ 300 and Polydyne™ 40, respectively, Lehigh Technologies, Inc.). The silane-terminated polyurethane binder was Desmoseal® S XP 2636 (Bayer MaterialScience LLC, Pittsburgh, Pa., USA). Certain of the composite materials also contained 0.5 weight percent carbon nanotubes (Baytubes® C 150 P, Bayer MaterialScience LLC) or 0.99 weight percent nylon fibers. The relative compositions (weight percentage) of the uncured composite materials are presented in Table 10.

TABLE 10

| Component | A | B | C | D | E | F |
|---|---|---|---|---|---|---|
| silane- | 58.87 | 58.87 | 58.58 | 58.58 | 58.29 | 58.29 |
| terminated | | | | | | |
| polyurethane | | | | | | |
| binder | | | | | | |
| 400 micron | — | 39.36 | — | 39.16 | — | 38.97 |
| rubber | | | | | | |
| particles | | | | | | |
| 50 micron | 39.36 | — | 39.16 | — | 38.97 | — |
| rubber | | | | | | |
| particles | | | | | | |
| carbon | — | — | 0.5 | 0.5 | — | — |
| nanotubes | | | | | | |
| nylon fibers | — | — | — | | 0.99 | 0.99 |
| DBN | 1.77 | 1.77 | 1.76 | 1.77 | 1.75 | 1.75 |

For samples A, B, E, and F, the rubber particles, binder, and additive particles, if present, were combined and spin mixed at 2400 RPM for 1 minute. For samples C and D, the mixture was spin mixed for 15 minutes. The resulting mixture was trowled flush into an aluminum mold ¼×10×12. The aluminum mold has been previously treated with mold release. The composite material layers were placed under standard laboratory conditions allowed to moisture cure for a minimum of seven days.

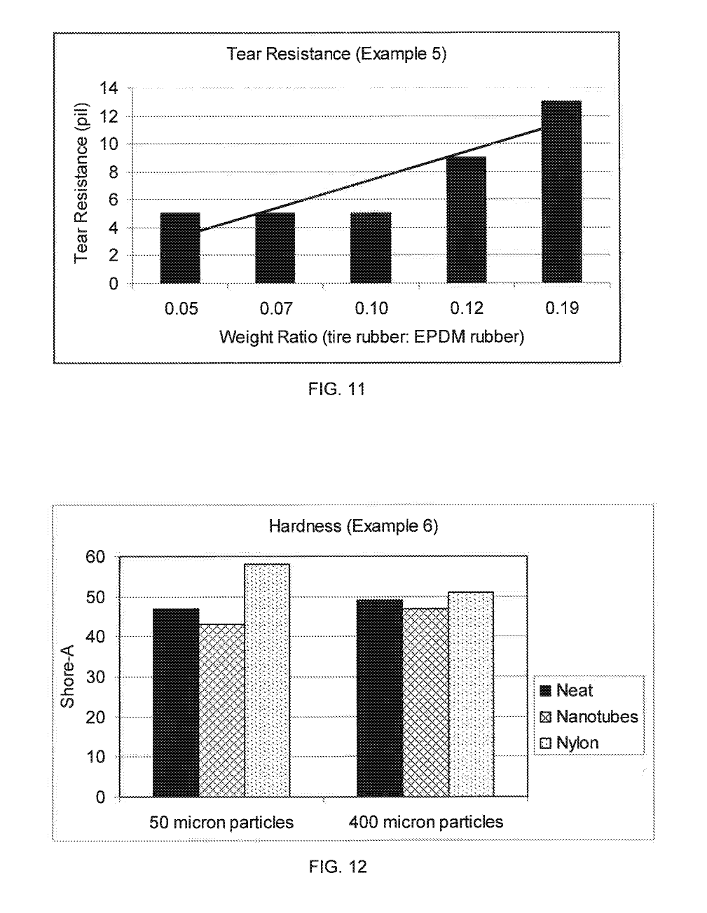

The cured composite materials were evaluated for Shore-A hardness (ASTM D2240), tensile strength and percentage elongation (ASTM D412), and tear resistance (ASTM D 624—Die C). The results are presented in Table 11 and FIGS. 12-15. FIGS. 12-15 each show two sets of composite materials, one set including 50 micron rubber particles (A, C, and E) and another set including 400 micron rubber particles (B, D, and F).

TABLE 11

| Property | A | B | C | D | E | F |
|---|---|---|---|---|---|---|
| hardness (Shore-A) | 47 | 49 | 43 | 47 | 58 | 51 |
| tensile strength (psi) | 171 | 116 | 194 | 123 | 209 | 149 |
| elongation (%) | 97 | 54 | 95 | 56 | 69 | 19 |
| tear resistance (pil) | 24 | 17 | 29 | 20 | 55 | 40 |

As shown in FIG. 12, the hardness was comparable between the set of composite materials including 50 micron rubber particles and the set of composite materials including 400 micron rubber particles. Relative to the neat composite materials (no carbon nanotubes or nylon fibers), within each set, the composite materials including carbon nanotubes exhibited lower hardness values and the composite materials including nylon fibers exhibited higher hardness values.

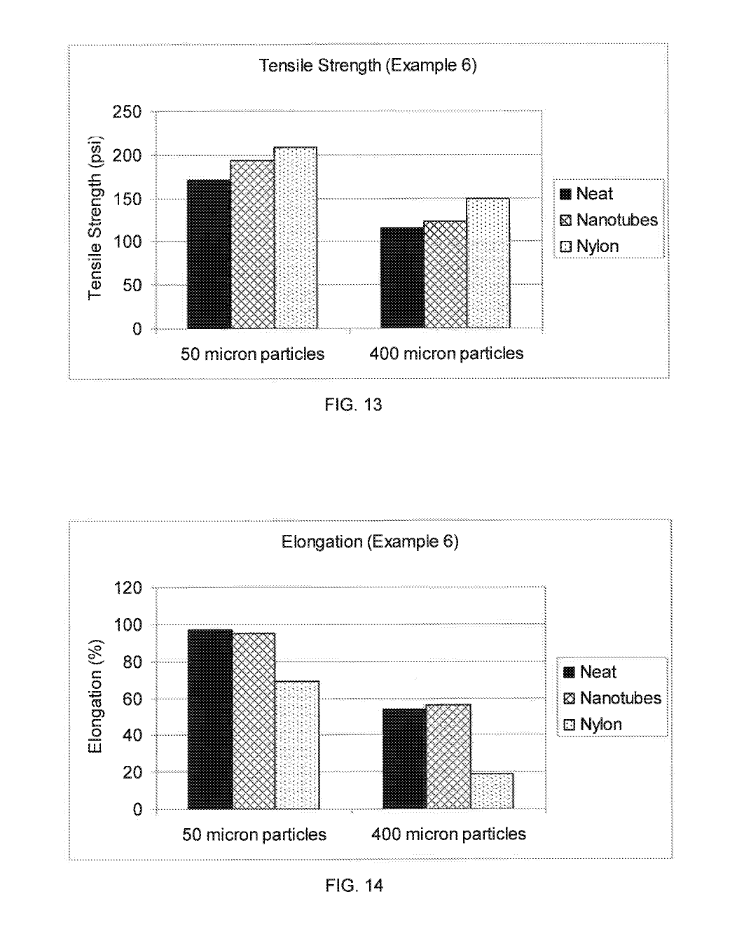

As shown in FIG. 13, between each set, the tensile strength of the composite materials including 50 micron rubber particles was greater than the tensile strength of the composite materials including 400 micron rubber particles. Relative to the neat composite materials, within each set, the composite materials including carbon nanotubes exhibited greater tensile strength. Within each set, the composite materials including nylon fibers exhibited greater tensile strength than both the neat composite materials and the composite materials including carbon nanotubes.

As shown in FIG. 14, between each set, the elongation of the composite materials including 50 micron rubber particles was greater than the elongation of the composite materials including 400 micron rubber particles. The composite materials including carbon nanotubes exhibited elongations that were comparable to the elongations exhibited by the neat composite materials, within each set. The composite materials including nylon fibers exhibited lower elongations than the neat composite materials and the composite materials including carbon nanotubes, within each set.

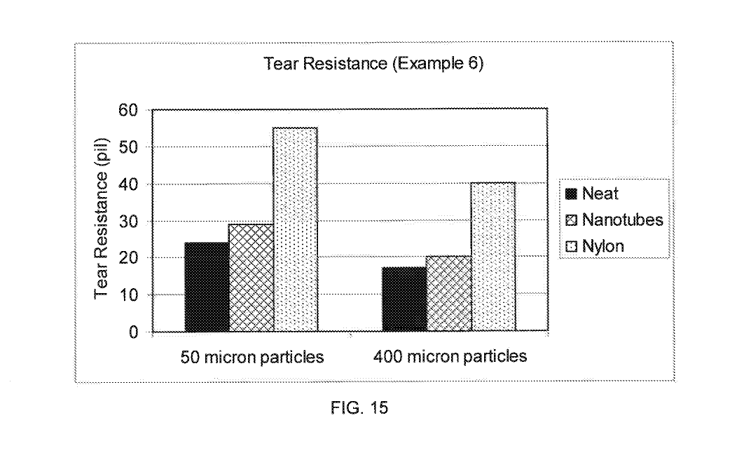

As shown in FIG. 15, between each set, the tear resistance of the composite materials including 50 micron rubber particles was greater than the tear resistance of the composite materials including 400 micron rubber particles for each composite material. Within each set, the addition of carbon nanotubes increased the tear resistance relative to the neat composite materials, and the addition of nylon fiber increased the tear resistance relative to both the neat composite materials and the composite materials including carbon nanotubes.

The present disclosure has been written with reference to various exemplary, illustrative, and non-limiting embodiments. However, it will be recognized by persons having ordinary skill in the art that various substitutions, modifications, or combinations of any of the disclosed embodiments (or portions thereof) may be made without departing from the scope of the invention as defined by the claims. Thus, it is contemplated and understood that the present disclosure embraces additional embodiments not expressly set forth herein. Such embodiments may be obtained, for example, by combining, modifying, or reorganizing any of the disclosed steps, ingredients, constituents, components, elements, features, aspects, characteristics, limitations, and the like, of the embodiments described herein. In this manner, Applicants reserve the right to amend the claims during prosecution to add features as variously described herein.

1. A composite material comprising:
rubber particles having an average particle size no larger than 500 microns; and a silane-terminated polyurethane binder.

2. The composite material of claim 1, comprising:
10-50 percent by weight rubber particles having an average particle size no larger than 500 microns; and
50-90 percent by weight silane-terminated polyurethane binder.

3. The composite material of claim 1, comprising:
35-50 percent by weight rubber particles having an average particle size no larger than 500 microns; and
50-65 percent by weight silane-terminated polyurethane binder.

4. The composite material of claim 1, wherein the rubber particles have an average particle size no larger than 50 microns.

5. The composite material of claim 1, wherein the composite material cures when exposed to atmospheric moisture, forming a solid composite material exhibiting tensile strength of at least 100 psi.

6. The composite material of claim 1, wherein the composite material cures when exposed to atmospheric moisture, forming a solid composite material exhibiting tensile strength of at least 200 psi.

7. The composite material of claim 1, wherein the composite material cures when exposed to atmospheric moisture, forming a solid composite material exhibiting percentage elongation of at least 60%.

8. The composite material of claim 1, wherein the composite material cures when exposed to atmospheric moisture, forming a solid composite material exhibiting percentage elongation of at least 100%.

9. The composite material of claim 1, wherein the composite material cures when exposed to atmospheric moisture, forming a solid composite material exhibiting tear resistance of at least 20 pil.

10. The composite material of claim 1, wherein the composite material cures when exposed to atmospheric moisture, forming a solid composite material exhibiting tear resistance of at least 30 pil.

11. The composite material of claim 1, wherein the rubber particles comprise rubber recycled from used tires.

12. The composite material of claim 1, wherein the rubber particles comprise cryogenically ground rubber recycled from used tires.

13. The composite material of claim 1, wherein the silane-terminated polyurethane binder comprises a reaction product of an amino-functional silane compound and a polyisocyanate, wherein the polyisocyanate comprises a reaction product of a polyether polyol and a diisocyanate.

14. The composite material of claim 1, further comprising a property modifier selected from the group consisting of carbon nanotubes and nylon fibers.

15. The composite material of claim 1, further comprising a silane curing catalyst.

16. A cured article of manufacture comprising the composite material of claim 1, the article of manufacture selected from the group consisting of: a running track; a wrestling mat; a play area mat; a floor or ground mat for humans or animals; a truck bed-liner mat; a landscaping article; a gasket; an article for sound abatement; a construction material; a speed bump; a bumper; a rail-road crossing pad; and a base for a traffic control device.

17. A composite material comprising:
10-50 percent by weight rubber particles having an average particle size no larger than 400 microns; and
50-90 percent by weight silane-terminated polyurethane binder;
wherein the composite material cures when exposed to atmospheric moisture, forming a solid composite material exhibiting tensile strength of at least 100 psi, percentage elongation of at least 60%, and tear resistance of at least 20 pil; and
wherein the rubber particles comprise cryogenically ground rubber recycled from used tires.

18. The composite material of claim 17, wherein the rubber particles have an average particle size no larger than 50 microns, and wherein the composite material cures when exposed to atmospheric moisture, forming a solid composite material exhibiting tensile strength of at least 175 psi, percentage elongation of at least 90%, and tear resistance of at least 30 pil.

19. A method of forming a composite material comprising:
combining rubber particles having an average particle size no larger than 500 microns and a silane-terminated polyurethane binder to form a composite mixture;
and curing the composite mixture to form the composite material,

20. The method of claim 19, wherein curing the composite mixture comprises exposing the composite mixture to atmospheric moisture.

21. The method of claim 19, wherein curing the composite mixture comprises exposing the composite mixture to a predetermined moisture level and temperature in a controlled temperature and humidity environment.

22. The method of claim 19, wherein the composite material formed by curing the composite mixture comprises 35-50 percent by weight rubber particles and 50-65 percent by weight silane-terminated polyurethane binder.

23. The method of claim 19, wherein the rubber particles have an average particle size no larger than 400 microns.

24. The method of claim 19, wherein the rubber particles have an average particle size no larger than 50 microns.

25. The method of claim 19, wherein the composite material formed by curing the composite mixture exhibits one or more material properties selected from the group consisting of tensile strength of at least 100 psi, percentage elongation of at least 60%, tear resistance of at least 20 pil, and combinations of any thereof.

26. The method of claim 19, wherein the composite material formed by curing the composite mixture exhibits one or more material properties selected from the group consisting of tensile strength of at least 200 psi, percentage elongation of at least 100%, tear resistance of at least 30 pil, and combinations of any thereof.

27. The method of claim 19, comprising:
combining cryogenically ground rubber particles recycled from used tires having an average particle size no larger than 400 microns and a silane-terminated polyurethane binder to form a composite mixture, the silane-terminated polyurethane binder comprising a reaction product of an amino-functional silane compound and a polyisocyanate, wherein the polyisocyanate comprises a reaction product of a polyether polyol and a diisocyanate; and curing the composite mixture to form the composite material.

28. The method of claim 19, further comprising combining a property modifier with the rubber particles and the silane-terminated polyurethane binder, the property modifier selected from the group consisting of carbon nanotubes and nylon fibers.
